(19) United States
(12) Patent Application Publication
(10) Pub. No.: US 2026/0162168 A1
(43) Pub. Date: Jun. 11, 2026

(54) GRAPH-BASED REPRESENTATION OF USER LATENT INTEREST FOR INSPIRATION-DRIVEN RECOMMENDATIONS

(71) Applicant: eBay Inc., San Jose, CA (US)

(72) Inventors: Kimberly Jane OLIVER, New York, NY (US); Leandro Pedro Fiaschetti, Buenos Aires (AR); Oded Zinman, Tel Aviv (IL); Nazmul Kabir Chowdhury, Nyack, NY (US); Yuri Michael Brovman, Miami, FL (US)

(21) Appl. No.: 19/410,381

(22) Filed: Dec. 5, 2025

Related U.S. Application Data
(60) Provisional application No. 63/729,203, filed on Dec. 6, 2024.

(51) Int. Cl. G06Q 30/0601

(52) U.S. Cl. CPC G06Q 30/06311

(57) ABSTRACT

Methods, systems, and computer storage media for providing an interest-driven recommendation engine in an item listing system are described. The interest-driven recommendation engine operates through three key stages: user interest modeling, item exploration, and recommendation delivery. In user interest modeling, user activity logs are used to build a hierarchical interest graph, capturing both short-term and long-term interests. A teacher-student Large Language Model “LLM” paradigm generates and scales these graphs efficiently, refining them to prioritize passion-driven interests over utilitarian needs. During item exploration, ranked interests are transformed into query expansions through a process called interest-to-recall. These queries are converted into embeddings, enabling the interest-driven recommendation engine to retrieve relevant items from the inventory. In recommendation delivery, a learning-to-rank neural network scores retrieved items for relevance, followed by a diversification step to balance closely aligned recommendations with inspirational suggestions. This ensures recommendations are both practical and engaging, fostering discovery and user satisfaction.

### CROSS-REFERENCE TO RELATED APPLICATIONS

This application claims the benefit of U.S. Provisional Application No. 63/729,203, filed on Dec. 6, 2024. The entire contents of which are incorporated herein by reference.

### BACKGROUND

Users can interact with generative artificial intelligence technologies in different types of applications and services to accomplish computing tasks. Generative AI refers to a class of AI systems and algorithms that are designed to generate new data or content that is similar to, or in some cases, entirely different from data they are trained on. Generative AI systems can create support text generation, image generation, music and audio generation, video generation and data synthesis. In particular, generative AI systems can support an item listing system in several ways to improve operational efficiency, customer engagement, and online shopping. For example, an item listing system may employ a generative AI system for content generation (e.g., product descriptions), personalized shopping experiences (e.g., recommendation engines), product discovery (e.g., visual search), and security management (e.g., fraud detection). The item listing system can leverage generative AI through Application Programming Interfaces (APIs), pre-trained models, and custom AI solutions to enhance item listing system functionality.

### SUMMARY

Various aspects of the technology described herein are generally directed to systems, methods, and computer storage media for, among other things, providing an interest-driven recommendation engine in an item listing system. The interest-driven recommendation engine is designed to deliver personalized and engaging recommendations by focusing on a user's broader and deeper interests, rather than solely relying on recent interactions.

The interest-driven recommendation engine integrates multiple technologies, including natural language processing (NLP), machine learning, and graph-based modeling, to achieve scalable, accurate, and diverse recommendations. The interest-driven recommendation engine operates through three key stages: user interest modeling, item exploration, and recommendation delivery. In user interest modeling, user activity logs (e.g., daily user activity logs like search queries) are used to build a hierarchical interest graph, capturing both short-term and long-term interests. A teacher-student Large Language Model “LLM” paradigm generates and scales these graphs efficiently, refining them to prioritize passion-driven interests over utilitarian needs.

During item exploration, ranked interests are transformed into query expansions through a process called interest-to-recall. These queries are converted into embeddings, enabling the interest-driven recommendation engine to retrieve relevant items from the inventory. In recommendation delivery, a learning-to-rank neural network scores retrieved items for relevance, followed by a diversification step to balance closely aligned recommendations with inspirational suggestions. This ensures recommendations are both practical and engaging, fostering discovery and user satisfaction.

By way of example, a user searches for “vintage cameras,” and the interest-driven recommendation engine models their broader interests, linking the query to passions like “photography” and “collectibles.” Using a hierarchical interest graph built by an LLM, the interest-driven recommendation engine prioritizes deeper interests, such as collecting rare cameras, over utilitarian needs. It then generates query expansions like “antique camera lenses” and “retro film” and converts them into embeddings, which are stored in a key-value database for future use. When the user accesses the item listing system at a later time, these stored embeddings are used to retrieve matching items. A learning-to-rank neural network scores and diversifies the results, offering both specific camera models and inspirational suggestions like photography books. This personalized and diverse recommendation list enhances the user's experience.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A-1G are schematics of an artificial intelligence system for providing interest-driven recommendations, in accordance with aspects of the technology described herein;

FIG. 2A is a block diagram of an artificial intelligence system for providing interest-driven recommendations, in accordance with aspects of the technology described herein;

FIG. 2B is a flow diagram associated with providing interest-driven recommendations, in accordance with aspects of the technology described herein;

FIG. 3 provides a first exemplary method of providing interest-driven recommendations in an artificial intelligence system, in accordance with aspects of the technology described herein;

FIG. 4 provides a second exemplary method of providing interest-driven recommendations in an artificial intelligence system, in accordance with aspects of the technology described herein;

FIG. 5 provides a third exemplary method of providing interest-driven recommendations in an artificial intelligence system, in accordance with aspects of the technology described herein

FIG. 6 provides a block diagram of an exemplary artificial intelligence system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION OF THE INVENTION

### Overview

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California.

An item listing system may also provide generative-AI-supported applications (“generative AI applications”) that leverage generative AI models (e.g., Large Language Models—“LLM”) to create, generate, or produce content, data or outputs. LLMs are a specific class of generative AI models that are primarily focused on generating human-like text. Generative AI models, like GPT (Generative-Pre-trained Transformer) and its variants, are designed to generate human-like text or other types of data based on the input they receive (e.g., via a prompt interface). These applications use generative AI to perform various task across different domains to provide improvement in automation, efficiency, and human-like interaction.

Recommendation systems are advanced algorithms designed to predict user preferences and suggest items or content that align with those preferences. Recommendation systems can be employed in a wide range of applications, from e-commerce platforms and streaming services to social media and news aggregators. Recommendation systems aim to improve user experience by reducing the cognitive effort required to find relevant items, while also driving engagement and sales for businesses.

At their core, recommendation systems leverage data about users and items to make predictions. Traditional methods include collaborative filtering, which identifies patterns by analyzing similarities among users or items, and content-based filtering, which suggests items similar to those a user has previously interacted with based on item attributes. Hybrid approaches combine these methods to mitigate their individual limitations, such as cold-start problems where insufficient user data exists.

Conventionally, recommendation systems are not configured with comprehensive computing logic and infrastructure to effectively provide personalized recommendations to users. By way of context, modern recommendation systems often incorporate graph-based methods and machine learning models to enhance accuracy and scalability. For instance, graph-based techniques create networks of users and items connected by shared attributes, enabling the discovery of hidden relationships. Machine learning models, particularly deep learning architectures, further improve recommendations by learning complex patterns from large datasets. Despite advancements, challenges remain. Conventional systems often suffer from recency bias, overemphasizing the most recent user interactions while neglecting broader, long-term interests. Additionally, many recommendation systems lack mechanisms to distinguish between utilitarian and passion-driven user behavior, resulting in less engaging recommendations. Scalability is another hurdle, as recommendation systems need to handle vast datasets in real time, often requiring computationally expensive resources.

By way of example, consider a user who recently searched for “wireless headphones” on an e-commerce platform. A traditional recommendation system might immediately suggest other models of wireless headphones, similar audio equipment, or accessories like headphone cases. If collaborative filtering is employed, the recommendation system might recommend items purchased by users with similar browsing behavior. Alternatively, a content-based approach might analyze the attributes of the searched headphones—such as brand, price range, or features—and suggest other products with matching characteristics.

While these methods can be effective in addressing the user's immediate goal, they often fall short of capturing broader interests or long-term preferences. For example, this user may have a passion for music production or be exploring options for a fitness-oriented lifestyle. If these underlying interests are not explicitly revealed through recent interactions, the recommendation may fail to suggest more diverse or engaging items, such as a high-quality microphone for recording music or sports earbuds tailored for running. This recency bias narrows the scope of recommendations, providing a short-term solution rather than inspiring deeper engagement.

Additionally, scalability presents another hurdle. Generating personalized recommendations for millions of users like this one requires substantial computational power, particularly when relying on graph-based or deep learning models. While graph methods could, in theory, identify connections between the user and items related to broader interests, their application at scale often becomes prohibitively expensive. Moreover, existing recommendation systems lack a nuanced understanding of the context behind the search. For instance, the recommendation system might suggest headphones based on necessity rather than recognizing a user's underlying passion for fitness or music.

Without mechanisms to differentiate between utilitarian “needs” and passion-driven “wants,” and with limited diversity in the recommendations, the user experience may feel repetitive and uninspired. For example, the recommendation system might repeatedly suggest minor variations of wireless headphones rather than introducing items like an advanced audio interface for music enthusiasts or a fitness tracker for active users. This narrow focus limits discovery, preventing the recommendation system from truly enriching the user's engagement with the platform. As such, a more comprehensive recommendation system—with an alternative basis for providing personalized recommendations functionality—can improve computing operations and interfaces for an item listing system.

### Description of Technical Solution

At a high level, an interest-driven recommendation engine is an advanced system designed to deliver personalized and engaging recommendations by focusing on a user's broader and deeper interests, rather than solely relying on recent interactions. This interest-driven recommendation engine integrates multiple technologies, including natural language processing (NLP), machine learning, and graph-based modeling, to achieve scalable, accurate, and diverse recommendations. The interest-driven recommendation engine operates through a pipeline comprising three main stages: user interest modeling, item exploration, and recommendation delivery.

In user interest modeling the interest-driven recommendation engine starts by collecting user activity logs, such as search queries or browsing history, on a regular basis (e.g., daily basis). This data serves as the input for building a hierarchical user interest graph. Using a Large Language Model (LLM), the interest-driven recommendation engine organizes user interactions into a graph that captures both transient and persistent interests. For efficiency, a teacher-student paradigm is employed: an LLM generates high-quality interest graphs, while a smaller fine-tuned LLM replicates this output for cost-effective scaling. The graph is then refined to rank and prioritize user interests, distinguishing between utilitarian “needs” and passion-driven “wants.”

During item exploration, based on the ranked interests, the interest-driven recommendation engine generates query expansions and maps these interests to a corresponding item inventory. This is achieved through a method called interest-to-recall, where the LLM transforms interest trajectories into a series of expanded queries. These queries are converted into embeddings using a fine-tuned model, such as eBERT (i.e., an extended Bidirectional Encoder Representations from Transformer), ensuring semantic alignment with the platform's inventory. The embeddings enable the interest-driven recommendation engine to retrieve relevant items by matching user interests with items in the catalog using nearest-neighbor search algorithms.

It is contemplated that the queries can be utilized both as embeddings and as plain text to ensure comprehensive recall. The queries can be processed directly through the item listing system search engine without being converted into BERT embeddings, allowing items to be retrieved based on textual matching and context provided by the search engine's algorithms. The queries can also be transformed into BERT embeddings, which are used in a k-nearest-neighbors (KNN) search to retrieve semantically similar items from the inventory.

Both recall methods—textual search and embedding-based retrieval—can be used during recommendation delivery to maximize the relevance and variety of the results. For example, if the query is “vintage cameras,” textual search may retrieve items with titles or descriptions explicitly containing the words “vintage” or “camera,” such as “Vintage Leica Camera.” Meanwhile, the embedding-based KNN search may identify related items like “Classic Film Cameras” or “Retro Photography Gear” that share semantic similarities with the query, even if exact keywords are not matched.

In recommendation delivery, the retrieved items are processed through a multi-step ranking and diversification framework. Initially, a learning-to-rank (LTR) deep neural network scores the items based on relevance and importance. Post-ranking, the interest-driven recommendation engine ensures diversity by including a mix of items closely aligned with the user's immediate interests and those that inspire broader discovery. This process ensures that the final recommendations are both relevant and engaging, balancing practical needs with opportunities for exploration.

By way of example, a user logs into an e-commerce platform and searches for “vintage cameras.” This activity is recorded and used by the interest-driven recommendation engine to model the user's broader interests. Through user interest modeling, the interest-driven recommendation engine constructs a hierarchical graph, linking this query to broader passions like “photography,” “collectibles,” and “vintage electronics.” An LLM is used initially to create the user interest graph for a subset of users to create a training dataset, after which a second LLM (e.g., a smaller, fine-tuned open-source LLM) is trained to replicate these outputs efficiently. This trained model is then deployed across millions of users for scalability. The interest-driven recommendation engine distinguishes between utilitarian needs, such as a replacement camera part, and deeper interests, such as collecting rare vintage cameras, prioritizing the latter.

By way of illustration, a proprietary large LLM is employed to generate user interest graphs, but this process is performed only once for a selected group of users, such as 12,000 in this example, to create a training dataset. The user interest graphs produced by the proprietary LLM are then used to train a smaller, open-source LLM to replicate the output of the larger model. This trained open-source LLM becomes the primary model used for generating user interest graphs across millions of users. The open-source LLM is deployed to handle ongoing updates, running daily to process users who have made new search queries within the last 24 hours. For example, the proprietary LLM might initially create detailed user interest graphs for a subset of users. These user interest graphs are then used to train the open-source LLM to produce similar outputs.

Next, during item exploration, the interest-driven recommendation engine identifies trajectories of different interest granularity within the graph, such as a pathway representing a broad user passion like “Photography” and more nuanced “deeper” trajectories connecting “Photography” to “rare photography accessories” and “retro film”. Using these trajectories, the LLM generates expanded queries like “classic film cameras,” “antique camera lenses,” and “vintage photography gear.” These expanded queries are converted into embeddings through a fine-tuned model, ensuring they align with the e-commerce platform's inventory. These embeddings are stored in a key-value database, enabling efficient retrieval of relevant items when the user accesses the e-commerce platform in the future. At that later time, the stored embeddings are used in a nearest-neighbor search to match items aligned with the user's interests. And, it is also contemplated that the expanded queries can be processed directly through the search engine, retrieving items based on keyword and contextual matches from the inventory.

Finally, in recommendation delivery, the retrieved items are scored using a learning-to-rank neural network, prioritizing relevance and importance. To ensure diversity, the system blends closely aligned items, such as specific vintage camera models, with inspirational suggestions, like unique camera cases or books on the history of photography. The user sees a personalized recommendation list that not only meets their immediate interest but also inspires broader discovery, enhancing their overall experience on the platform.

### Example Systems and Resources

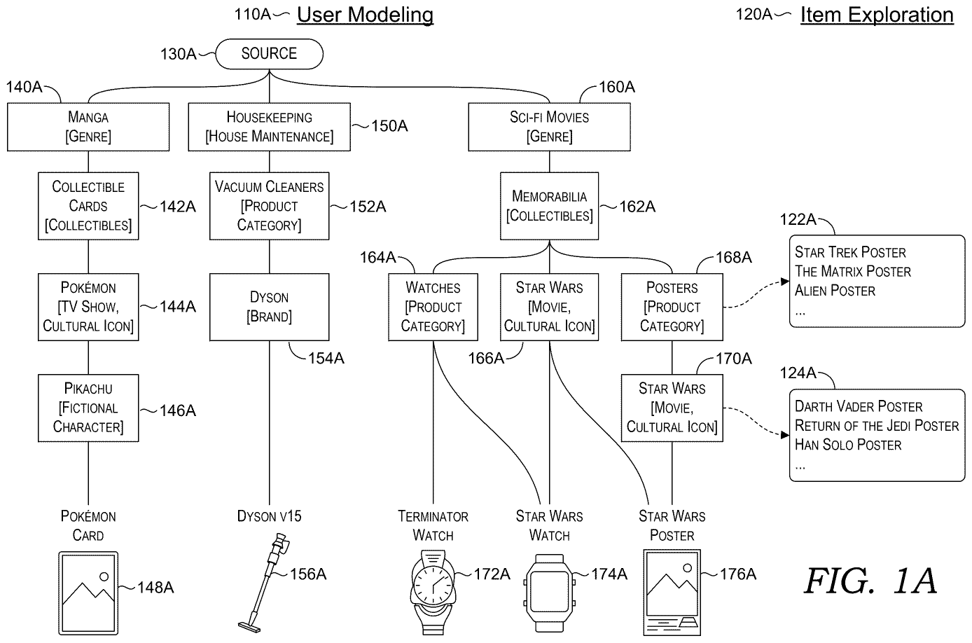

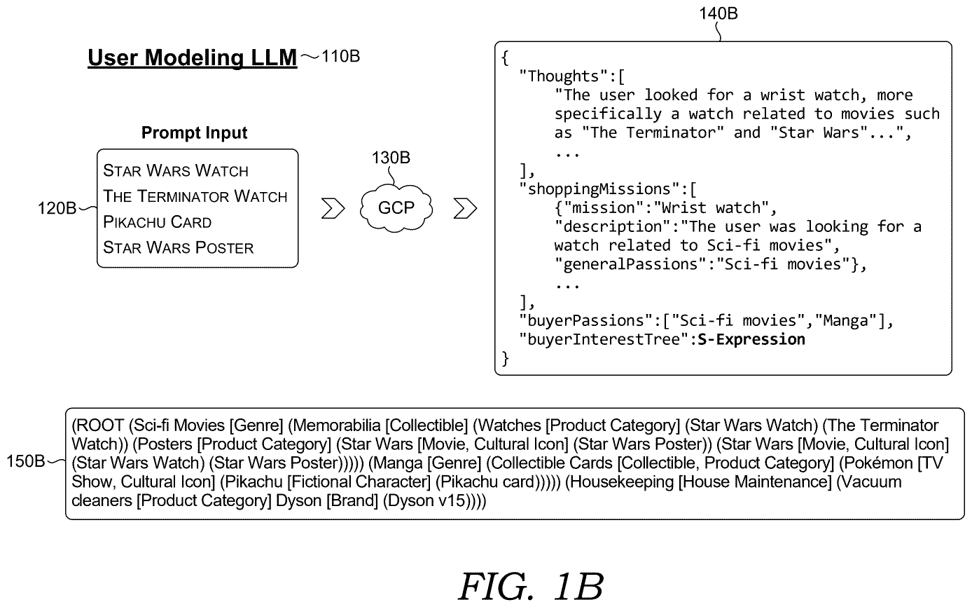

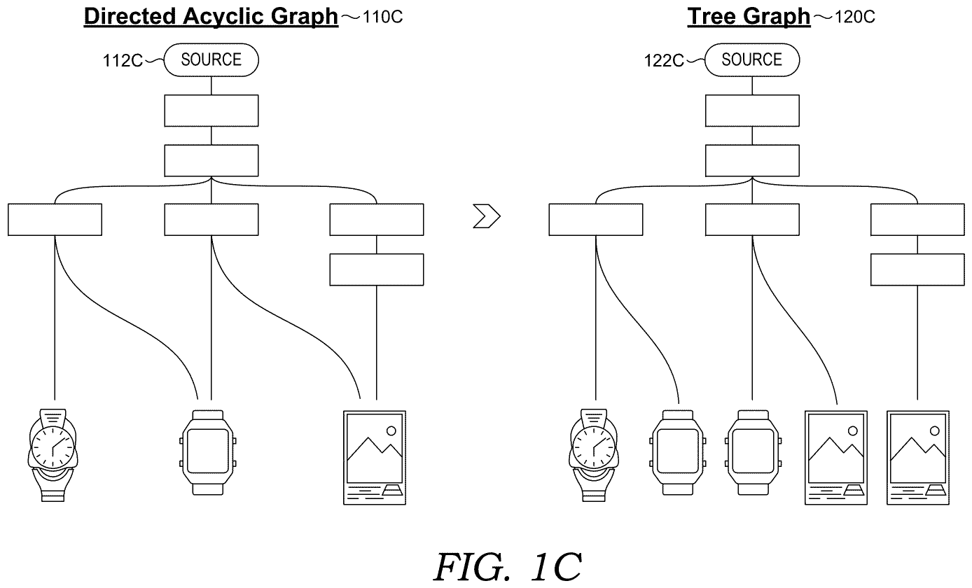

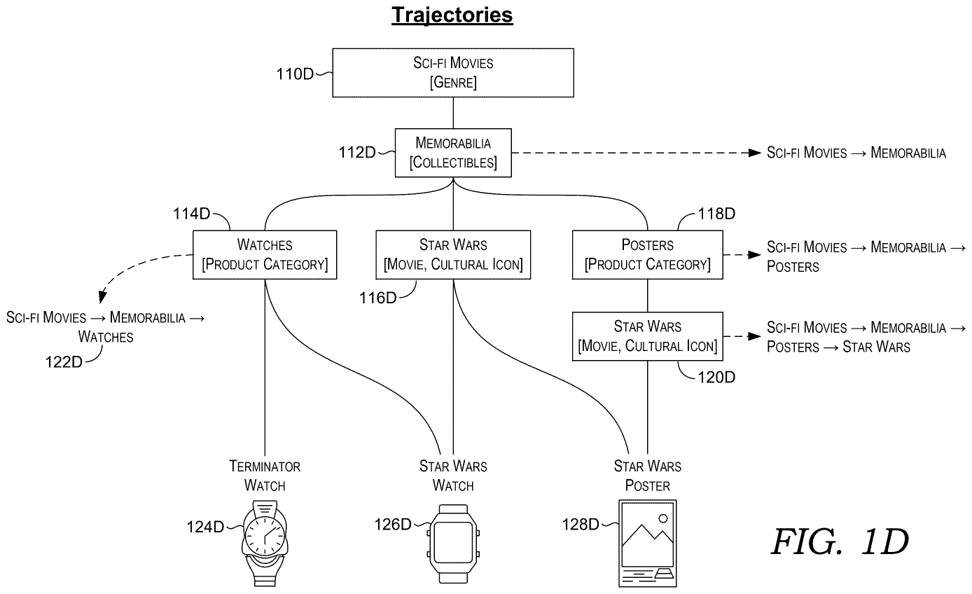

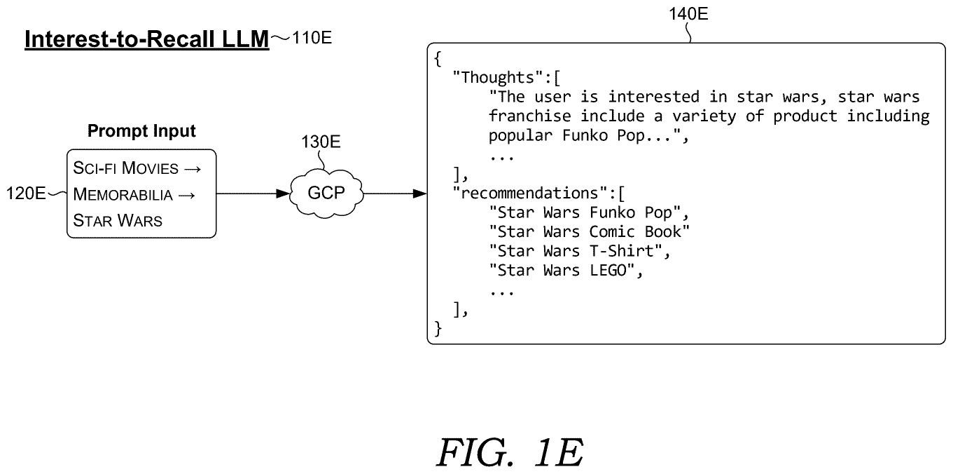

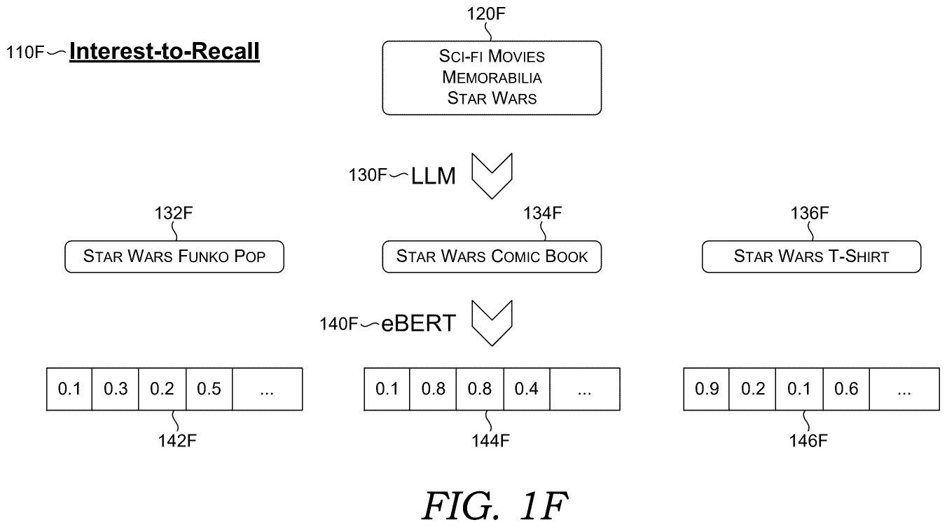

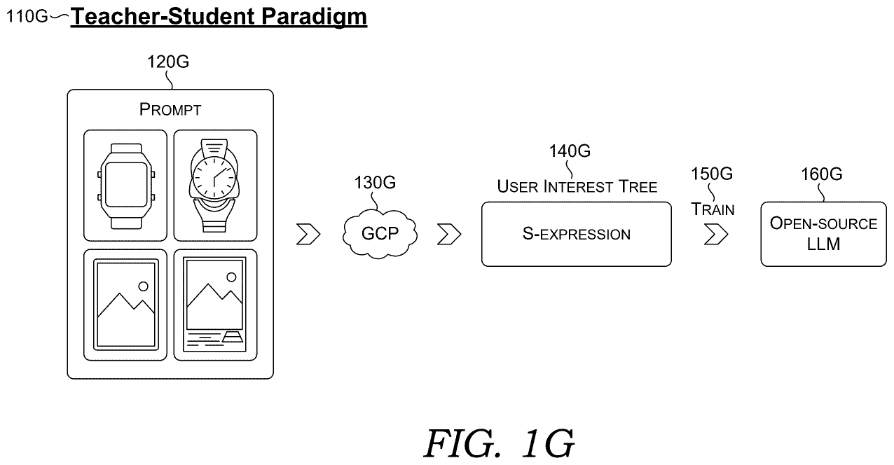

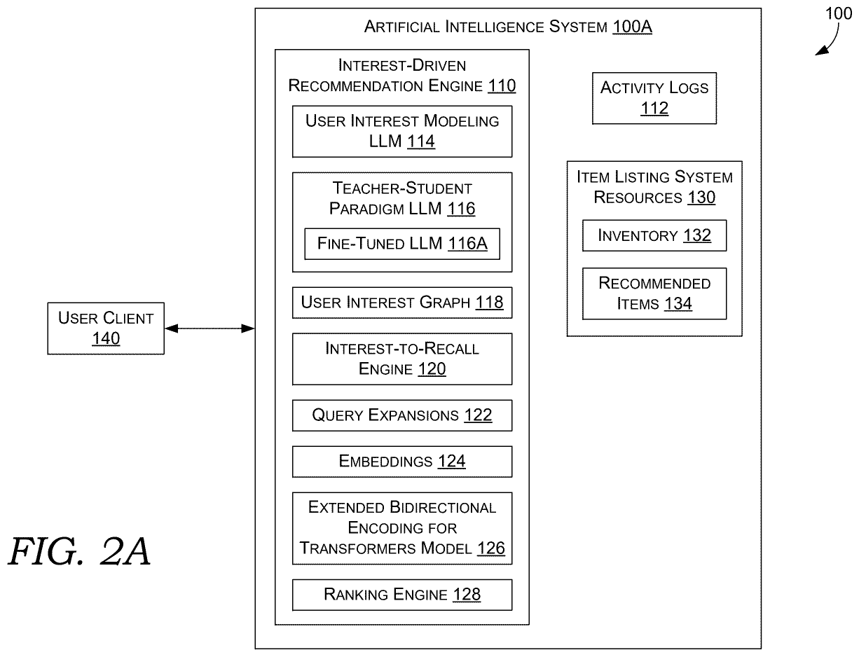

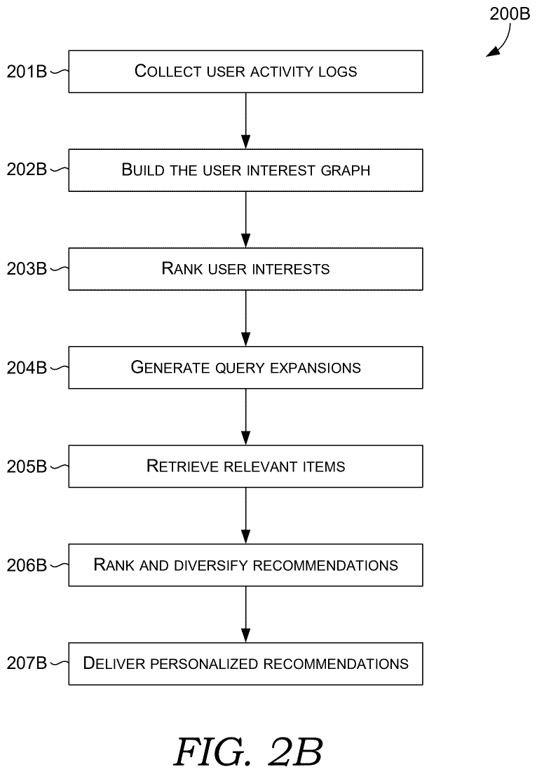

Aspects of the technical solution can be described by way of examples and with reference to FIGS. 1A-1G, 2A and 2B. By way of background, traditional recommendation systems typically suggest items similar to those a user has already interacted with. However, the current technical solution aims to uncover the underlying drivers of consumer behavior by identifying the deeper passions that influence shopping patterns. This allows a recommendation system (i.e., an interest-driven recommendation engine) to recommend products from categories the user has not previously explored. The technical solution leverages graph structures, generated through Large Language Models (LLMs), to model buyers' interests in a hierarchical framework. These graphs facilitate the differentiation of distinct user interests and enable dynamic exploration across varying levels of interest granularity.

Traditional recommendation systems predominantly rely on short-term user interactions, such as Recently Viewed Items (RVI). While this approach is effective for capturing users' immediate objectives, it inherently introduces a recency bias, which reinforces repetitive behavior patterns. This bias often hinders users from discovering new items or interests, thereby limiting the system's capacity to foster broader engagement. To overcome this limitation, the technical solution transitions from item-focused to interest-driven recommendations by identifying and leveraging both transient and enduring shopper interests. Operationally, an interest-driven recommendation engine is designed to identify users' deeper passions and inspire them with diverse, cross-category recommendations that align with these interests while maintaining compatibility with an item listing system inventory. This shift not only enhances user engagement but also expands the horizon for item exploration and discovery.

The technical solution is structured around two core components: user modeling and item exploration. Central to this framework is an advanced user modeling strategy designed to extract and represent the latent interests driving specific shopping behaviors. By identifying a user's core passions—beyond ephemeral, short-term goals—the interest-driven recommendation engine can recommend items that resonate with users' intrinsic motivations.

In user modeling (capturing latent interests), effective user modeling necessitates the compression of a user's interaction history into a compact and meaningful representation. This is typically achieved by representing users as dense embeddings that encapsulate their latent interests. Notable methodologies include architectures such as PinnerFormer and variational autoencoder (VAE)-based approaches, which facilitate the extraction of nuanced interest vectors.

The advent of LLMs has revolutionized user modeling by offering enhanced capabilities for knowledge comprehension, generalization, and summarization. LLMs excel in identifying underlying connections across shopping missions, enabling the inference of broader interests from seemingly disparate behaviors. For instance, LLMs can deduce that two distinct shopping missions (e.g., purchasing hiking gear and photography equipment) relate to a shared passion for outdoor adventures.

Additionally, LLMs' advanced summarization capabilities allow for the compression of extensive user activity logs into concise, interpretable descriptions. Techniques such as PALR and EmbSum leverage these capabilities to improve next-item prediction by integrating unstructured text summaries into their models. Structured representations generated by LLMs further enable the creation of user profiles that effectively balance specificity and generality.

In one instance, an algorithm can be used for identifying user journeys by clustering items and using LLMs to label each cluster, but it relies on hard clustering, which cannot capture overlapping interests. For example, a “Lebron James Rookie Card” could belong to multiple categories, such as “Lebron James,” “Rookie Cards,” and “Los Angeles Lakers,” but their approach does not handle such overlapping interests within a single user. Additionally, in that instance, the approach does explore how user journeys can enhance item-level recommendations. In another instance, the focus may be on identifying interest patterns and cluster transitions, while the technical solution emphasizes providing inspirational recommendations based on users' core interests.

Users of an item listing system—often composed of enthusiasts and collectors pursuing rare or unique items—offer a compelling foundation for uncovering user passions. However, not all shopping missions reveal deep-seated interests. For example, a user purchasing a mobile phone out of necessity does not exhibit the same level of engagement as a collector hunting for rare memorabilia. This underscores a critical challenge: effective user modeling must distinguish between shopping missions driven by passion versus those motivated by necessity—essentially discerning what a user wants versus what they need. Addressing this nuanced distinction requires a thoughtful definition of underlying motivations and tailored strategies to model them effectively.

In interest-driven item exploration, user modeling is integrated with item exploration to facilitate a transition from reactive to proactive recommendation strategies. By aligning identified interests with the available inventory, the interest-driven recommendation engine promotes diverse cross-category listings that inspire discovery. This paradigm encourages users to explore beyond their habitual preferences, creating opportunities for serendipitous engagement with new products.

Accordingly, the interest-driven recommendation engine operates based on the following:

Structured Textual Graph Representation: The technical solution includes a graph representation designed to emphasize enduring user interests. This graph organizes user passions at multiple levels of granularity, enabling the capture of latent interests that transcend immediate, transient interactions.

Unified Framework for User Modeling and Item Exploration: The technical solution includes an integrated paradigm that bridges user interest modeling with item exploration, effectively mapping user passions to eBay's diverse inventory. This connection facilitates personalized recommendations that align with both user preferences and platform offerings.

Multi-Level Interest Graph for Enhanced Item Inspiration: The technical solution leverages a user interest graph that supports multi-level exploration, enabling both deeper dives into specific interests and broader discovery across related categories. By traversing this graph, the interest-driven recommendation engine provides users with richer, more inspiring item recommendations.

LLM-Friendly Graph Transformation Methodology: To ensure compatibility with LLMs, the technical solution includes a token-efficient method for generating a Directed Acyclic Graph (DAG) representation of user interests. This involves transforming the DAG into a tree structure expressed as an S-Expression optimizing it for LLM processing while preserving the graph's hierarchical richness. An S-expression (short for Symbolic Expression) is a way of representing nested data, commonly used in Lisp programming languages and some other symbolic processing systems. An S-expression can represent both atomic data (like numbers or symbols) and structured data (like lists or trees).

By leveraging advanced user modeling techniques and the transformative capabilities of LLMs, the technical solution transcends the limitations of recency-biased recommendation systems. It provides an effective framework for understanding and addressing users' deeper interests, fostering engagement through diverse and personalized recommendations. This innovation enables connecting users with items that resonate with their passions, while simultaneously expanding the discovery potential across the platform.

User modeling framework includes two key components: building the user graph and interest extraction. Building the user graph involves organizing the user's site activity into a structured graph that encapsulates broader interest concepts. The graph serves as a relational map of the user's latent passions, enabling targeted exploration and analysis. Interest extraction involves ranking the user interests identified in the constructed graph and extracting trajectories that represent significant user interests. These trajectories serve as focal points for generating inspiration and guiding recommendations.

The item exploration method bridges the gap between text-based interest representations and an item listing platform's inventory space. By mapping extracted interests to the platform's catalog, the interest-driven recommendation engine aligns recommendations with user preferences while maintaining inventory relevance.

As shown in FIG. 1A, user modeling 110A and item exploration 120A are linked because understanding a user's interests (user modeling) provides the foundation for generating relevant and inspiring recommendations (item exploration). By constructing an accurate representation of a user's preferences, item exploration can effectively map these interests to specific items in the inventory, ensuring recommendations align with both the user's passions and the platform's offerings. This connection ensures a seamless flow from identifying what users care about to presenting them with items that satisfy and expand those interests.

User modeling (building the user graph) involves the construction of a graph representation of the user's interests, powered by an LLM. This structured graph offers several advantages, including relational organization, where the graph organizes user interests hierarchically and relationally, capturing both broad categories and specific nuances; scalable exploration, where the graph supports multi-level traversal, enabling exploration at varying depths—from high-level themes to granular interests; and enhanced explainability, where the structured format provides clear insights into user interests, making the recommendation process more transparent and interpretable.

The graph is structured as a Directed Acyclic Graph (DAG) with a single source node that serves as the root. Excluding sink nodes, the graph follows a tree-like structure: each node (except sink nodes) has exactly one parent, while sink nodes deviate from this pattern by having multiple parents, enabling soft clustering. This structure allows the graph to capture nuanced relationships among user interests.

The nodes in the graph are organized by their distance from the source node 130A, denoted as levels (e.g., L1, L2, etc.). For instance, in the example, “Sci-fi Movies,” 160A, “Housekeeping” 150A, “Manga,” 140A, and Technology (not shown) are L1 nodes, representing broad, unrelated interests, while their respective child nodes, such as “Memorabilia,” 162A “Vacuum Cleaners” 152A, “Collectible Cards,” 142A and “Mobile Phones” (not shown) are L2 nodes, representing more specific sub-interests. Sink nodes represent the narrowest user interests, corresponding to specific search queries made by the user.

Nodes encapsulate user interests, and traversing from the source to the sink nodes reveals increasingly detailed aspects of those interests. For example, the edge “Sci-fi Movies” 160A→“Memorabilia” 162A refines the broader interest in sci-fi movies by highlighting a preference for memorabilia. Consequently, nodes should be understood in the context of their ancestors, as the hierarchical structure provides meaningful organization. This arrangement mirrors the logic of hierarchical clustering, where user search queries are grouped and named at each junction, ensuring that the graph reflects both the breadth and depth of a user's interests.

In graph node properties and construction, each node in the user interest graph is defined by two key properties:

Interest Name (String): A descriptive label for the interest, generated dynamically by the Large Language Model (LLM). This name provides an unconstrained, human-readable description of the interest.

Interest Tags (List of Strings): A set of structured tags derived from a predefined list of 35 interest categories. These tags add semantic structure to the LLM-generated interest names, ensuring consistency and alignment with a fixed taxonomy.

With reference to FIG. 1A, FIG. 1A illustrates an exemplary implementation of a user interest graph and recommendation delivery system. The technical solution leverages fine-tuned large language models (LLMs) and efficient embedding-based retrieval to translate user behavior into structured, semantically-rich graphs that enable precise item recommendations.

On the left side, user modeling 110A is based on user activity that is ingested from a source node 130A, which could be recent search queries, browsing history, or purchase behavior. From this data, a fine-tuned proprietary LLM initially generates a user interest graph, mapping observed actions to a hierarchy of concepts. For instance, a user who searches for “Dyson cordless vacuum” triggers links to the domain of “Housekeeping” 150A, a higher-level theme. This theme is connected to the category “Vacuum Cleaners” 152A, then to the brand “Dyson” 154A, and finally to a specific product node like “Dyson v15” 156A.

In another example, a user might engage with Pokémon-related content. That interest leads from the broader category “Manga” 140A to “Collectible Cards” 142A, to “Pokémon” 144A, then to the character “Pikachu” 146A, and ultimately to a purchasable item like a specific “Pokémon Card” 148A. These directed edges define contextual relationships between abstract user intents and concrete items.

A similar path is shown for entertainment-driven interests. A user interested in “Sci-Fi Movies” 160A may have previously watched or searched for “Star Wars.” The system then maps that behavior through “Memorabilia” 162A, then to “Star Wars” 166A as a cultural icon, and links out to product categories such as “Watches” 164A and “Posters” 168A. Specific associated items include a “Terminator Watch” 172A “Star Wars Watch” 174A or a “Star Wars Poster” 176A.

On the right side, the graph enables item exploration 120A by linking categories and entities to live inventory. The product category “Posters” 168A, for example, branches to items like “Star Trek Poster,” “The Matrix Poster,” or “Alien Poster” 122A. In contrast, more specific intent nodes like “Star Wars” 170A enable retrieval of tightly aligned items such as “Darth Vader Poster” “Return of the Jedi Poster” or “Han Solo Poster” 124A. This branching structure allows both general and narrow targeting during recommendation delivery.

This user interest graph is not only used for direct recall via nearest-neighbor embedding search, but also as an input to train a smaller open-source LLM. The smaller model is retrained daily to regenerate user graphs for millions of users based on new activity, ensuring that the system remains scalable and cost-efficient while preserving accuracy. FIG. 1A illustrates how user interest modeling is dynamically linked to item retrieval, allowing personalized recommendations that are both broad and deep-supporting utilitarian queries (e.g., “buy vacuum cleaner”) and passion-driven discovery (e.g., “collectible sci-fi memorabilia”).

During the graph construction process, the graph is constructed using the user's site activity—specifically, their search queries. Search queries are ideal for this purpose as they provide a concise and direct representation of user intent. The construction process leverages the LLM's capabilities through a structured in-context learning approach, which follows these steps, as shown in FIG. 1B.

FIG. 1B illustrates how a user modeling LLM 110B processes a set of item interaction prompts 120B to generate a structured representation of a user's interests using a large language model deployed on a cloud platform (e.g., Google Cloud Platform—GCP 130B). The system takes as input a list of items the user engaged with—like “Star Wars Watch,” “The Terminator Watch,” “Pikachu Card,” and “Star Wars Poster”—and interprets them to infer the user's shopping intent, preferences, and passions.

On the right, the LLM output 140B includes multiple layers of understanding:

Thoughts summarize observations such as “the user looked for a wrist watch related to movies like Star Wars and The Terminator,” showing contextual generalization from specific items. ShoppingMissions distill actionable insights like a “mission” to find a wristwatch, and a general passion for “sci-fi movies,” connecting item browsing behavior to a broader goal. BuyerPassions captures deeper affinities, like “sci-fi movies” and “manga,” for long-term profiling. The buyerInterestTree is generated as a structured S-expression, offering a tree-like representation of the user's conceptual interest graph.

Block 150B shows this interest tree fully expanded, linking genres, product categories, brands, and cultural icons into a hierarchical structure. For instance: “Star Wars Watch” is classified under “Watches” (product category), linked to “Star Wars” (movie/cultural icon), and further to “Sci-fi Movies” (genre). “Pikachu Card” traces through “Collectible Cards” to “Pokémon” and finally to “Manga” and “Fictional Character.”

This structured output enables downstream recommendation or retrieval systems to match user interests with semantically related items (e.g., suggesting a “Star Trek Poster” based on affinity for sci-fi movie memorabilia) even if the user hasn't interacted with those items before. FIG. 1B thus demonstrates how LLM-driven inference over a small set of user interactions can be used to construct a rich and actionable interest profile.
1. Input Framework for the LLM:
   System Prompt: Provides the LLM with its role and overarching objectives.
   Task Description: Outlines the task of passion-identification and graph construction.
   Fixed List of Interest Types: Supplies the predefined taxonomy of interest categories. For example, Collectible, Genre, Cultural Icon, Product Category, Style, Brand, Fitment, Athlete, Movie, Music, TV Show, Game, Comics, Product, Team, Sport League, Fitness, Celebrity, Fictional Character, Hobby, Upkeep and Maintenance, Parts, Personal Essentials, House Essentials, House Maintenance, Consumer Electronics, Home Decor, Child Care, Fashion, Luxury, Automotive, NSFW, User Query, Theme, and OTHER.
   Output Schema: Specifies the structure of the graph output.
   Few-Shot Examples: Includes five illustrative examples to guide the LLM's reasoning.
   User Search Queries: Represents the user activity input.
2. Bottom-Up Reasoning Workflow: The LLM processes user search queries to infer broader interest concepts, following a bottom-up reasoning approach:
   “Thoughts” Generation: The LLM writes a narrative about the buyer's preferences based on observed activity.
   Shopping Mission Identification: Distinct shopping missions are identified, each linked to specific user interests.
   Passion Extraction: Core passions underlying these missions are distilled into key concepts.
3. Output Representation: The final user-directed acyclic graph (DAG) is expressed as an S-Expression, a compact textual format. This structure is preferred over alternatives like JSON due to its efficiency and token economy, enabling the LLM to produce concise and well-organized output.

In tree conversion for textual representation a more compact and intuitive textual representation is generated, where the Directed Acyclic Graph (DAG) is transformed into a tree structure, as shown in FIG. 1C.

FIG. 1C illustrates how user interests and related items can be structured and transformed for effective recommendation delivery. On the left side, a Directed Acyclic Graph 110C with source node 112C is used to model user interests in a rich and flexible format. The Directed Acyclic Graph (DAG) allows each node, such as a product category or cultural reference, to be connected to multiple related items or concepts. For example, a user might be interested in a Star Wars-themed wristwatch, which could be simultaneously linked to the categories “Watches,” “Memorabilia,” and “Sci-Fi Movies.” These overlapping relationships enable a more nuanced understanding of the user's intent, as a single item may appear in multiple branches depending on its relevance

On the right side of FIG. 1C, a Tree Graph 120C with source node 122C is shown as a simplified version of the DAG. In this structure, each item is assigned to a single parent node, and the branching is strictly hierarchical. This means that even if an item relates to multiple interests, it will appear only once—usually under the most relevant or highest-weighted category. For instance, the Star Wars watch may now only appear under the “Watches” branch of the tree, rather than being shared across multiple conceptual paths. This flattening of the graph into a tree is designed to improve system efficiency and optimize the delivery of recommendations to users.

In both cases, the graphs begin with a common source node, representing the origin of the user's interactions—such as a search query or past behavior. In the DAG format, the system preserves complex semantic relationships between user interests and items. In the tree format, the system transforms those relationships into a streamlined structure that is easier to traverse, cache, and display in a user interface. By converting from the DAG to the tree, the system is able to retain rich contextual modeling while delivering clean, efficient recommendation lists tailored to user preferences.

While most of the DAG adheres to the properties of a tree, sink nodes—nodes with multiple parent connections—violate the tree property of having a single parent. To address this, we duplicate sink nodes for each parent relationship, effectively converting the graph into a valid tree structure. This transformation enables us to represent the tree relationships efficiently using a structured text format, such as an S-Expression. This format is particularly advantageous due to its simplicity and compactness, making it ideal for LLM processing and reducing token usage while maintaining readability and structure.

Turning to interest extraction and prioritization framework, by way of context, the user interest graph generated by the LLM may lack two properties essential for effective recommendations: Differentiating between “needs” and “wants”: distinguishing utilitarian interests from passion-driven ones. Identifying the most salient interests: determining which interests should be prioritized and displayed.

Addressing the “Need vs. Want” problem includes implementing a blacklist-based pruning mechanism that removes nodes associated with utilitarian “needs.” For example, the blacklist (i.e., need categories) can includes the following interest tags: Parts; Personal Essentials; Personal Essential Product; House Essentials; House Maintenance; Automotive; NSFW; and OTHER. For example, if a subgraph contains a node tagged as “House Maintenance,” such as “Housekeeping,” the entire subgraph is excluded from further processing.

During ranking and prioritizing interests, the interest-driven recommendation engine ranks and prioritizes interests at the L1 node level, focusing on the top-level subgraphs of the user interest graph. The following features and weights contribute to the scoring process:
1. Interest Type Scores (Weight: 1.0):
   A recursive scoring method evaluates the L1 subgraph.
   Each interest tag is assigned a score between 0 and 1 based on its passion-driven intensity.
   Example: “Hobby” (1.0)> “Consumer Electronics” (0.5), as electronics might often reflect necessity-driven purchases.
   The aggregated score for the L1 subgraph is calculated recursively as the average score of all nodes, weighted by their children.
2. Number of Unique Meta Categories (Weight: 0.5):
   Counts the number of distinct meta categories inferred from search queries, based on the dominant category on search result pages.
3. Number of Unique Leaf Categories (Weight: 0.3):
   Tracks the diversity of unique leaf categories within the search queries.
4. Number of Sink Nodes (Weight: 0.2):
   Measures the count of sink nodes within the L1 subgraph, indicating the depth and specificity of interests.
5. Number of Sessions (Weight: 0.2):
   Considers the frequency of sessions where search queries under the L1 subgraph occurred.

### Feature Scoring Formula

For a given feature f with a value v, the normalized score is computed as:

$${score}_{l}^{( f )} ( v ) = \frac{min ( {P}_{max}^{( f )} , v ) - {P}_{min}^{( f )}}{{P}_{max}^{( f )} - {P}_{min}^{( f )}} Where {P}_{max}^{( f )}$$

is a parameter that defines a score considered good for the specific feature f

$${P}_{min}^{( f )}$$

is the lower possible value for the feature f (e.g., 1 for number of sink nodes).

### Overall L1 Node Scoring

To calculate the overall score of the L1 node l a weighted average of the feature score is calculated:

$${score L 1}_{l} = ( {v}_{l}^{( 1 )} , … , {v}_{l}^{( d )} ) = {\sum }_{f = 1}^{d} {I}^{( f )} \cdot {score}_{l}^{( f )} ( {v}_{l}^{( f )} )$$

Where I^{(f)} is the feature importance, d is the number of features, and

$${v}_{l}^{( f )}$$

is the value of the L1 node l and the feature f.

The ranking may use a weighted scoring system based on features reflecting the importance and relevance of each L1 node. This scoring system ensures that high-priority interests are identified and ranked based on their relevance, diversity, and passion-driven intensity, allowing for effective personalization and recommendation.

Item exploration, the technical solution employs a method for item recall, which bridges user interests with relevant item suggestions. The preceding user modeling and interest selection steps are designed to efficiently distill user interests, ensuring that most of the computational complexity is handled before the item exploration phase. This preparatory work enables item exploration to focus on generating inspiration and expanding recall.

Leveraging LLMs for item exploration in this technical utilizes the LLM world knowledge to generate additional relevant item suggestions aligned with the user's identified interests. The process begins by transforming the user's interests into trajectories—sequential paths within the interest graph that represent the progression or relationships among user passions as shown in FIG. 1D.

FIG. 1D illustrates how the system identifies interest trajectories—the meaningful paths a user can take through their inferred interests—to support item exploration and recommendation generation. The figure starts with a high-level interest such as Sci-fi Movies 110D at the top. From there, the system identifies a related mid-level interest, Memorabilia 112D, which represents a more specific aspect of the user's sci-fi movie engagement. This connection forms the beginning of several possible trajectories.

Beneath Memorabilia 112D, the system identifies different product-related branches the user might be interested in. One branch leads to Watches 114D, another to Star Wars 116D, and another to Posters 118D. Each branch represents a different way the user's higher-level interest may express itself in the item catalog. These branches then connect to specific products the user might want or discover, such as a Terminator Watch 124D, a Star Wars Watch 126D, or a Star Wars Poster 128D.

Each dashed arrow on the right shows an example trajectory, which is simply the sequence of connected interest nodes the system follows. For example, the trajectory Sci-fi Movies→Memorabilia→Watches 122D reflects the idea that someone interested in sci-fi movies might also be interested in memorabilia, and among those memorabilia items, watches related to those movies. Similarly, another trajectory Sci-fi Movies→Memorabilia→Posters 118D→Star Wars 120D shows how the system can move from a broad genre to a type of collectible, then to a product category like posters, and finally to a specific cultural property such as Star Wars.

These trajectories allow the system to generalize beyond the user's exact past actions. Even if the user has only interacted with a Star Wars Poster 128D in the past, the system can understand that this interest fits along a broader sci-fi collectible trajectory and can therefore recommend related items like Terminator Watch 124D or additional sci-fi posters. In simple terms, FIG. 1D shows how the system turns a user's scattered interests into structured paths that guide the retrieval of relevant and inspirational items.

Turning to FIG. 1E and the Interest-to-Recall framework, the technical solution includes Interest-to-Recall (I2R) method that uses the LLM to generate query expansions based on these trajectories. The LLM takes the interest trajectory as input and outputs a set of expanded queries that capture nuanced and relevant variations of the user's interests.

FIG. 1E illustrates how the system leverages a large language model (LLM) to generate item recall recommendations based on interest trajectories. Specifically, the diagram shows an Interest-to-Recall LLM 110E, which receives a structured prompt input 120E consisting of a trajectory like: Sci-Fi Movies→Memorabilia→Star Wars. This trajectory reflects a user's progression from a general interest in sci-fi films to a more specific focus on collectibles and, ultimately, to a franchise such as Star Wars.

The prompt is passed to a generative cloud platform (GCP) 130E, which executes the Interest-to-Recall LLM using the provided trajectory. Based on this input, the model generates an output 140E that includes two main components: a “Thoughts” section and a “Recommendations” section. The “Thoughts” section contains natural language reasoning that reflects how the model interprets the prompt. For example, the model may output: “The user is interested in Star Wars. The Star Wars franchise includes a variety of products including popular Funko Pop . . . ”—demonstrating contextual understanding of the domain.

The “Recommendations” section then lists specific products aligned with the inferred interest path, such as:
Star Wars Funko Pop
Star Wars Comic Book
Star Wars T-Shirt
Star Wars LEGO

This architecture allows the system to reason across conceptual chains of interest and suggest relevant items that may not have been directly viewed or clicked by the user before. By taking structured interest paths like Sci-Fi Movies→Memorabilia→Star Wars, the LLM can generate imaginative and contextual recall results that bridge gaps between the user's general interests and specific, diverse catalog items. FIG. 1E shows how the Interest-to-Recall LLM 110E operationalizes structured user interests into actionable product suggestions, enabling discovery beyond traditional nearest-neighbor methods.

The process follows a structured in-context learning approach, comprising of:
1. System Prompt: Establishes the LLM's role and context.
2. Task Description: Defines the goal of generating query expansions.
3. Output Schema: Specifies the format of the expanded queries.
4. Few-Shot Examples: Provides illustrative examples of input trajectories and corresponding outputs.
5. Input Trajectory: Represents the user's interest path derived from the interest graph.
   The output of the LLM is a JSON list of strings, where each entry represents a query expansion. An example of such an output might include:

```
json
  [
    “LeBron James rookie cards”,
    “rare basketball trading cards”,
    “Los Angeles Lakers collectibles”
]
```

With reference to FIG. 1F, query expansion refinement with an LLM (e.g., eBERT) includes taking each query expansion generated by the LLM and further refining the query expansion using eBERT, a BERT model fine-tuned on the item listing system data (e.g., inventory). This step ensures that the query expansions are optimized for inventory, accounting for domain-specific nuances such as category hierarchies, item descriptions, and search relevance.

FIG. 1F illustrates the operation of an Interest-to-Recall system 110F that uses a language model pipeline to evaluate item relevance for a user based on prompt input 120F. The prompt includes hierarchical interest cues—such as “SCI-FI MOVIES,” “MEMORABILIA,” and “STAR WARS”—which are provided as input to a large language model 130F. Based on this prompt, the system generates example recall candidates such as a “STAR WARS FUNKO POP” 132F, a “STAR WARS COMIC BOOK” 134F, and a “STAR WARS T-SHIRT” 136F.

Each recall candidate is then transformed into an embedding using an eBERT model 140F (or equivalent encoder), producing corresponding scoring vectors. For example, the STAR WARS FUNKO POP is represented by a feature vector 142F, the STAR WARS COMIC BOOK by a vector 144F, and the STAR WARS T-SHIRT by a vector 146F. These feature vectors numerically encode various semantic or contextual relevance signals, and can be subsequently used for scoring, ranking, or filtering based on alignment with user preferences.

There exists several advantages for adopting this approach including: efficiency based on offloading much of the computational effort to earlier stages, the item exploration step operates efficiently, leveraging preprocessed user interests; contextual relevance based on the LLM's knowledge and eBERT's fine-tuning ensure that the generated queries align closely with user intent and eBay's inventory; scalability from the structured process allows for seamless integration of new user trajectories and categories, enabling continuous improvement in recall and inspiration quality. This framework ensures that the interest-driven recommendation engine not only matches user interests but also inspires discovery by presenting diverse and relevant item recommendations.

The teacher-student paradigm is employed for token-efficient generation, which is essential for updating user graphs at scale, a critical aspect of our system. With over millions daily users conducting search queries the item listing system, the need to generate an equivalent number of updated user interest graphs arises. This task is computationally expensive due to the complexity of the graphs, which require long inputs and outputs.

With reference to FIG. 1G, teacher-student paradigm is provided for cost-efficient graph generation to balance accuracy and efficiency. In the teacher-student paradigm an LLM acts as a teacher to train a second LLM (e.g., a smaller fine-tuned open-source LLM). This approach allows us to leverage the strengths of high-performing models while deploying a cost-effective solution at scale. Advantages include significant reduction in input and output token lengths and maintaining high fidelity to the teacher model's outputs.

FIG. 1G illustrates a teacher-student paradigm 110G used to efficiently train a smaller, open-source language model to reproduce user interest representations derived from a larger proprietary model. The flow begins with a set of product-based user prompts 120G, such as watches and posters that reflect a user's browsing behavior or historical preferences. These prompts act as input signals indicating interest in a particular product domain.

These prompts are processed by a large, proprietary model hosted on a cloud platform (e.g., GCP 130G). This teacher model analyzes the input prompts and generates an S-expression—a structured representation of a user interest tree 140G. The S-expression encodes the hierarchical relationships among various interest categories and subcategories. For example, the model might generate an S-expression indicating that both “smartwatches” and “Star Wars posters” fall under broader interests like “gadgets” or “sci-fi memorabilia.”

This structured interest representation is not used directly for serving users at scale due to the computational cost of the large teacher model. Instead, a training phase (150G) uses this generated user interest tree data to teach a smaller open-source LLM 160G how to infer similar structures from prompts. This student model is compact, more efficient, and designed to run on low-latency systems that serve millions of users. In essence, the figure demonstrates how a powerful proprietary LLM is used only once to generate high-quality training outputs, and a lightweight open-source LLM is trained to mimic those outputs—enabling scalable, real-time inference of interest graphs across the entire user base.
Teacher Model (e.g., Gemini Flash 1.5)
Model: Google's Gemini Flash 1.5.
Purpose: Generate high-quality user interest graph datasets using an in-context learning procedure.
Methodology: Utilizes a structured prompt with the following components:
   System Prompt
   Task Description
   Allowed Interest Types List
   Output Schema
   Few-Shot Examples
   Input Queries

### Student Model: Fine-Tuned LLM (e.g., Mistral 7B)

Model: A fine-tuned Mistral 7B chat model.
Fine-Tuning Method:
   LoRA Adapters: Lightweight adapters were trained to replicate the S-Expression output generated by the teacher model.
   Task: Mimic the teacher model's graph generation process, focusing on efficient input-output compression.

The fine-tuned student model significantly reduces both input and output token lengths, making it more efficient while retaining the essential features of the teacher's output.

| Prompt | | Student (Mistral |
|---|---|---|
| Structure | Teacher (Gemini Flash 1.5) | 7B) |
| Input | System Prompt, Task Description, Allowed Interest | Task Description, |
| | Types List, Output Schema, Few-Shot Examples, Input | Input Queries |
| | Queries | |
| Output | Thoughts, Shopping Missions, Buyer Passions, Buyer | Buyer Interest Tree |
| | Interest Tree | |

| Average Tokens | Teacher | Student |
|---|---|---|
| Input | 4648 | 274 |
| Output | 1400 | 290 |

The deployment of the interest-driven recommendation engine leverages advanced hardware and optimized models to achieve high performance and efficiency. For user modeling, the fine-tuned model (e.g., Mistral 7B) is deployed across GPUs (e.g., 33 NVIDIA A100) using LLM dynamic batching, allowing for high-throughput and efficient inference across a large volume of user activity. Item exploration tasks utilize an LLM platform that can take advantage of\context comprehension and high-quality output generation capabilities.

This approach provides several key benefits. Scalability is achieved by enabling the generation of user interest graphs for millions of users daily at significantly reduced computational costs. Efficiency is enhanced by lowering token consumption during input and output stages, which accelerates processing times. Accuracy is maintained by effectively training the student model to replicate the teacher model's high-quality outputs, ensuring consistency and precision. Cost-effectiveness is realized by reducing reliance on expensive proprietary models while preserving overall system performance. The teacher-student paradigm ensures that the system remains both scalable and economically sustainable, effectively meeting the demands of a large and dynamic user base of item listing platforms.

By way of illustration, the end-to-end interest-drive recommendation engine is designed to process user activity efficiently, extract meaningful interests, and deliver personalized item recommendations through a three-phase process. The first phase involves user activity log collection, where a daily offline Spark job identifies users who have made new search queries within the last 24 hours. These activity logs, which capture the queries, are then published to a Kafka queue for further near-real-time processing, creating a seamless data pipeline to support the system's operations.

The second phase, user modeling, employs a near-real-time service powered by a series of LLM-driven steps. The process begins with building a user-specific interest graph from search queries, which organizes interests into broader categories and identifies relationships between them. The interest graph is further refined to extract ranked interests and corresponding trajectories. Corresponding trajectories refer to the behavioral pathways or temporal patterns that evolve alongside a user's specific ranked interests. These trajectories capture how a user's interaction with a given topic changes over time—such as increasing engagement, diversification into subtopics, or movement between related categories. By identifying these trajectories, the system can track not just the static importance of an interest, but its progression, volatility, or deepening relevance to the user. For example, a user ranked highly for “Star Wars memorabilia” might show a trajectory that begins with browsing action figures, shifts to purchasing vintage items, and later expands into coFor each identified trajectory, the system generates query expansions using the Interest-to-Recall method, transforming these expansions into eBERT embeddings that ensure semantic alignment with the platform's inventory. The final output, including the buyer graph, trajectories, refined query expansions, and embeddings, is stored in a key-value database for quick access during recommendation generation.

The final phase focuses on item ranking to deliver personalized recommendations. When a user visits the homepage, the system retrieves relevant items using query expansions processed through eBay's search engine and embedding matches conducted via approximate-nearest-neighbors (ANN) algorithms. Hundreds of recalled items are scored and prioritized using learning-to-rank (LTR) models based on deep neural networks, narrowing the list to a few dozen top items. Post-ranking diversification ensures the recommendations include a mix of close matches tied to the user's search history and inspirational suggestions that encourage broader discovery. This approach guarantees that the final recommendations are both relevant and engaging.

The system offers several key advantages. It scales to handle millions of daily user interactions with real-time processing capabilities, efficiently balancing lightweight recall mechanisms with deep neural ranking models for speed and relevance. Personalization is at the forefront, ensuring a tailored user experience that blends practical recommendations with opportunities for discovery. Together, these elements create a robust and dynamic recommendation system that excels in scalability, efficiency, personalization, and diversity.

With reference to FIG. 2A, FIG. 2A illustrates item listing system 100 including artificial intelligence system 100A, interest-driven recommendation engine 110, activity logs 112, teach-student paradigm LLM 116, fine-tuned LLM 116A, user interest graph 118, interest-to-recall engine 120, query expansions 122, embeddings 124, extended Bidirectional Encoding for Transformers Model 126, ranking engine 128, item listing system resources 130, inventory 132, recommended items 134, and user client 140.

Item listing system 100 enables users to browse and interact with items on the platform. Item listing system 100 provides the interface where users view inventory 132 of the item listing system and recommended items 134 that are tailored to their interests and facilitates seamless integration with other systems. Item listing system resources 130 include the integrated set of tools, data structures, and computational processes required to retrieve, rank, and display items from the inventory to users in a personalized and efficient manner.

These item listing system resources 130 encompass the inventory database, which holds detailed information about available items, and the search and retrieval algorithms that identify relevant listings based on user embeddings or query expansions. Item listing system resources 130 also include the interfaces that connect the backend processes to the user-facing client, ensuring seamless communication and real-time updates. Users interact with item listing system 100 through the user client 140, which could be a mobile app or a web interface. The user client 140 serves as the front-end portal where search queries, clicks, and other interactions are initiated, collected, and sent to the backend for processing.

Artificial intelligence system 100A provides a comprehensive backend infrastructure responsible for processing user data, modeling interests, and generating personalized recommendations. Artificial intelligence system 100A incorporates the interest-driven recommendation engine 110, provides the recommendation logic by combining machine learning models, natural language processing, and graph-based techniques.

The recommendation process begins with the activity logs 112, which include user actions such as search queries, clicks, and browsing history. Activity logs 112 enable capturing user intent and are processed at a predefined cadence (e.g., daily) to keep the interest-driven recommendation engine 110 updated. Activity logs 112 are consumed by the user interest modeling LLM 114, a machine learning model designed to extract meaningful insights from user behavior. The user interest modeling LLM 114 constructs user interest graph 118, a hierarchical directed acyclic graph (DAG) that organizes user interests into broad categories and specific subcategories, effectively mapping relationships between transient and persistent preferences.

To ensure scalability and efficiency, the teacher-student paradigm LLM 116 is employed. A LLM acts as the teacher, generating high-quality user interest graphs, while a smaller, fine-tuned LLM serves as the student, replicating these outputs for cost-effective scaling. This setup allows the interest-driven recommendation engine 110 to handle millions of users daily without compromising the quality of the interest graphs.

Within the user interest graph 118, meaningful paths, or trajectories, are identified using the interest-to-recall engine 120. These trajectories represent specific sequences of user interests, such as a path from “vintage cameras” to “rare photography accessories.” The trajectories guide the generation of query expansions 122, which are variations of user queries designed to capture a broader range of relevant items. Query expansions 122 are converted into embeddings 124, dense vector representations generated by extended Bidirectional Encoding for Transformers Model 126 (i.e., eBart), a BERT model fine-tuned on the platform's inventory data (i.e., inventory 132) to ensure semantic alignment with item descriptions. When embeddings are generated to align with an inventory of an item listing system, it means that the embeddings (dense vector representations of data) are designed to capture and reflect the semantic and contextual relationships between user queries and the items available in the system's inventory.

Each item in the inventory is represented by its own embedding, which encodes features like its title, description, category, and other metadata. Similarly, user queries or interest-based trajectories are converted into embeddings. By aligning these embeddings, the system ensures that the representation of a user query or interest trajectory is comparable to the representations of items in the inventory.

This alignment enables the interest-driven recommendation engine 110 to match user intents with relevant items using methods like nearest-neighbor search. For example, if a user's query is “vintage cameras,” the interest-driven recommendation engine 110 generates an embedding for the query and searches for items in the inventory whose embeddings are closest in the vector space, such as items labeled “antique cameras” or “retro photography gear.” This alignment ensures that the retrieved items are semantically relevant to the user's intent, even if the exact wording does not match. As such, aligning embeddings with an inventory ensures that the interest-driven recommendation engine's representations of user interests and item metadata exist in the same vector space, enabling accurate and efficient matching of queries to items.

These embeddings, once stored, are also structured to support batch processing during high-traffic periods, ensuring scalability for real-time retrieval demands. The embeddings can be stored in a key-value database and are later used to retrieve matching items from the inventory 132. Inventory 132 contains items available on the platform, categorized and indexed for efficient retrieval. When the user accesses the item listing system 100 in a subsequent session, the embeddings 124 are retrieved and matched to items in the inventory using a nearest-neighbor search algorithm. This step leverages optimized approximate-nearest-neighbors (ANN) techniques to maintain high performance even for large-scale inventories. The retrieved items are then processed by the ranking engine 128, which scores and prioritizes them based on relevance, importance, and user preferences.

To ensure diversity and user engagement, the ranking engine 128 integrates a post-ranking diversification step. This step blends items closely related to the user's recent interests with inspirational suggestions that encourage broader discovery. The final recommend items 134 list is then seamlessly, ensuring a real-time, personalized browsing experience for the user.

Through this tightly integrated system, the platform delivers an engaging and dynamic user experience, leveraging advanced artificial intelligence and natural language processing to align recommendations with user interests while fostering exploration and discovery.

For clarity and efficient reference, a glossary of key terms and concepts pertinent to the technical solution is provided below.

User Interest Graph: A hierarchical directed acyclic graph (DAG) that organizes user interactions into broad and specific interests, capturing relationships and trajectories to represent both transient and persistent preferences.

Nodes: Represent user interests in the graph, with source nodes indicating broad categories and sink nodes corresponding to specific, granular interests.

Edges: Denote relationships between nodes in the user interest graph, showing how specific interests are connected to broader ones.

Sink Nodes: Nodes at the bottom of the graph hierarchy that may have multiple parents, representing the most specific user interests.

Hierarchical Clustering: A technique mirrored in the user interest graph where user queries are grouped into progressively broader or more specific categories.

Passion-Driven Interests: Interests prioritized in the graph over utilitarian needs, reflecting deeper, long-term user preferences.

Utilitarian Needs: Practical or necessity-driven user interests, often pruned or deprioritized in the user interest graph to focus on more engaging recommendations.

Trajectory: A path through the user interest graph that represents a specific sequence of related interests, used to guide query expansion and item exploration.

Large Language Models (LLMs): Advanced natural language processing models, such as Gemini Flash 1.5, used to build and refine user interest graphs by processing user activity data.

Teacher-Student Paradigm: A training approach where an LLM generates high-quality outputs (teacher) and a smaller, fine-tuned LLM replicates these outputs (student) for cost efficiency. The second LLM is a smaller fine-tuned LLM that replicates a graph generation processes of the user interest graph based on a teacher-student paradigm.

LoRA Adapters: Lightweight adapters used to fine-tune the student LLM, enabling it to replicate the teacher LLM's output efficiently.

In-Context Learning: A technique where LLMs generate output by leveraging prompts that include task descriptions and example data, guiding the model to create meaningful representations.

Interest-to-Recall: A method for transforming user interest trajectories into query expansions that broaden the scope of item retrieval.

Query Expansions: Variations of user queries generated to capture a wider range of relevant items from the inventory.

Embeddings: Dense vector representations of query expansions created using a fine-tuned model, such as eBERT, for semantic alignment with the platform's inventory.

eBERT: An extended BERT model fine-tuned on platform-specific data, used to generate embeddings for query expansions.

Approximate-Nearest-Neighbors (ANN): An algorithm for efficiently matching embeddings to semantically similar items in the inventory.

Key-Value Database: A data storage system used to store user interest graphs, embeddings, and related metadata for fast retrieval during recommendation generation.

Learning-to-Rank (LTR): Machine learning models used to score and rank retrieved items based on their relevance to the user's preferences.

Diversification: A process that ensures the final recommendation set includes a mix of closely aligned items and inspirational suggestions to balance practical relevance with discovery.

Personalized Recommendations: Tailored suggestions delivered to users in real-time, combining relevance, diversity, and inspiration to enhance user experience.

Transient Preferences: Short-term user interests influenced by recent behavior, trends, or context. These preferences often shift quickly and may not reflect long-standing interests.

Persistent Preferences: Long-term, stable user interests that remain consistent over time and are derived from repeated behaviors or deeply rooted affinities.

Predefined Need Categories: Structured groups of user intents or goals that are established in advance, such as “gift shopping,” “personal upgrade,” or “collectibles.” These categories help the system interpret user behavior and tailor recommendations toward common motivation types.

Scoring Nodes: Nodes within the user interest graph that are assigned numerical values representing their relative importance, relevance, or influence based on factors such as frequency, recency, trajectory position, or predefined weighting rules. These scores help determine which interests should drive recall and recommendation generation.

Scoring Features: The measurable signals or attributes used to compute node scores, such as how often a user interacted with an interest, how recently the interaction occurred, how strongly the interest connects to other nodes, or how well it predicts meaningful recommendations. These features provide the inputs for the system's scoring logic.

A first session refers to the initial interaction between a user and an item listing system, during which the user provides activity data, such as search queries or browsing behavior. This data is used to construct or update the user's interest graph. During the first session, the system identifies the user's interests, generates query expansions, and computes embeddings, which are stored in a key-value database for later use. No item recommendations are typically delivered in this session, as it focuses on data collection and modeling.

A subsequent session occurs when the user later accesses the item listing system, such as visiting the item listing interface or homepage. In this session, the stored embeddings from the first session are retrieved and used to find matching items via a nearest-neighbor search. The item listing system then ranks and diversifies the retrieved items to present a personalized recommendation list. This session focuses on delivering tailored and engaging recommendations based on the user's previously modeled interests.

By way of illustration, the technical solution provides an end-to-end recommendation system that combines Large Language Models (LLMs) for user modeling, eBERT embeddings for query expansion, and learning-to-rank (LTR) models for item ranking. It operates through three key phases: user activity collection, interest graph generation, and item recommendation. This structured approach ensures scalability, efficiency, and high-quality personalized recommendations.

The process begins with user activity collection. A daily Spark job processes user activity logs, such as search queries, from the last 24 hours. These logs are filtered for users with new interactions and published to a Kafka queue for real-time processing. This pipeline ensures fresh data input into the recommendation system.

Next, the system generates user interest graphs using an LLM, for example, an open source LLM fine-tuned, such as Mistral 7B, for the task of generating an S-Expression that represents the user interest graph. It is contemplated that any LLM can be leveraged to optimize the number of input and output tokens, enhancing scalability and improving efficiency. The open source LLM was fine-tuned offline to replicate the user graphs generated by a proprietary LLM (teacher-student paradigm), such as Gemini Flash 1.5, instructed in an in-context-learning manner to builds high-quality graphs from search queries. The system organizes interests into hierarchical nodes, ranking them based on importance metrics like interest type scores and session frequency. Interest trajectories of varying granularity and depth are identified within the graph. The LLM generates query expansions for these trajectories, which are transformed into embeddings using eBERT, a BERT model fine-tuned on platform-specific data. The final user graph, ranked interests, query expansions, and embeddings are stored in a key-value database for online use.

In the item recommendation phase, the interest-driven recommendation engine retrieves and ranks items to present personalized suggestions. When a user visits the homepage, relevant items are recalled using query expansions through the platform's search engine and embedding matching via approximate-nearest-neighbors (ANN) algorithms. The retrieved items are ranked using an LTR deep neural network, narrowing the results to a prioritized list of a few dozen. To enhance user engagement, the system diversifies the final recommendations by including a mix of closely matched items and inspirational suggestions that encourage discovery. These recommendations are delivered to the user in real-time, balancing immediate relevance with broader exploration.

This approach ensures a seamless flow from data collection to recommendation delivery. The user activity logs feed into hierarchical interest graphs, which guide query expansion and embedding transformations. The final recommendations leverage recall, ranking, and diversification to provide a personalized and engaging experience, ensuring high-quality user satisfaction and platform scalability.

With reference to FIG. 2B, FIG. 2B, illustrates a schematic 200B associated with providing an interest-driven recommendation engine in accordance with embodiments described herein. The technical solution of the interest-driven recommendation engine can be explained by way of steps and an example advertising campaign.

At step 201B, Collect User Activity Logs—The process begins by gathering user activity logs, such as search queries and browsing history, on a daily basis. The activity logs are processed (e.g., a Spark job that processes these logs) offline to identify users who have engaged with the platform in the last 24 hours. The collected data is then published to a queue (e.g., a Kafka queue) enabling real-time consumption for downstream processing.

At step 202B, Build the User Interest Graph-A near-real-time service consumes the user activity logs from the queue and uses them to construct hierarchical user interest graphs. An open source LLM (e.g., Mistral 7B) fine-tuned on the task (using a teacher-student paradigm), generates the user graphs. This includes organizing search queries into broader and deeper interest clusters. Nodes in the graph represent user interests, with source nodes representing broad categories and sink nodes capturing specific, narrow interests. Relationships between nodes are defined based on user behavior, and the graph is refined to prioritize passion-driven interests over utilitarian needs by pruning nodes tagged with predefined “need” categories.

At step 203B, Ranking User Interests—The generated interest graph is analyzed to rank user interests based on their importance. Each node is scored using features such as interest type scores, the number of associated search sessions, and diversity metrics like unique meta and leaf categories. A weighted scoring formula aggregates these features, assigning higher priority to interests that reflect enduring user passions. This ranking ensures that the most relevant and meaningful interests are prioritized for further processing.

At step 204B, Generating Query Expansions—For each ranked interest trajectory within the graph, the interest-driven recommendation engine generates expanded queries to capture related items in the inventory. This process, known as Interest-to-Recall, leverages the fine-tuned LLM to transform interest trajectories into detailed query expansions. The expanded queries are formatted as structured text, ensuring token efficiency and semantic clarity. These queries are then passed through eBERT, a BERT model fine-tuned on data (e.g., inventory) of an item listing platform, to generate embeddings that align with the platform's inventory.

At step 205B, Retrieving Relevant Items—The embeddings generated during query expansion are used to retrieve relevant items from the platform's inventory. This is achieved through a nearest-neighbor search algorithm applied to an item embeddings index. The retrieval step identifies a broad pool of items that match the user's interests, forming the basis for further ranking and refinement.

At step 206B, Ranking and Diversifying Recommendations—The retrieved items undergo a ranking process to determine their relevance and importance. A learning-to-rank (LTR) deep neural network assigns scores to each item based on features such as user preferences, item attributes, and contextual relevance. To enhance the user experience, the interest-driven recommendation engine performs post-ranking diversification, ensuring that the final recommendation set includes a mix of items closely aligned with the user's current interests and inspirational suggestions that encourage discovery.

At step 207B, Delivering Personalized Recommendations—The finalized recommendation list is delivered to the user in real-time. This list balances practical relevance with inspirational diversity, presenting items that not only match the user's immediate needs but also foster engagement by introducing them to new possibilities. By combining hierarchical interest modeling, efficient query generation, and advanced ranking, the interest-driven recommendation engine ensures a personalized and engaging user experience.

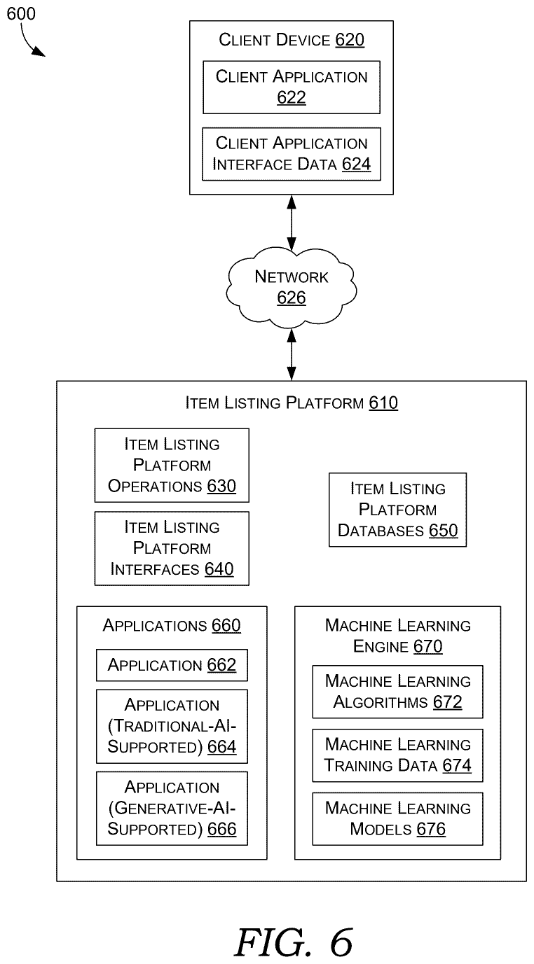

Aspects of the technical solution can be described by way of examples and with reference to FIGS. 1A-1G, 2A, and 2B. FIG. 2A is a block diagram of an exemplary technical solution environment, based on example environments described with reference to FIGS. 6, 7 and 8 for use in implementing embodiments of the technical solution are shown. Generally, the technical solution environment includes a technical solution system suitable for providing the example item listing system 100 in which methods of the present disclosure may be employed. In particular, FIG. 2A shows a high level architecture of the item listing system 100 in accordance with implementations of the present disclosure. Among other engines, managers, generators, selectors, or components not shown (collectively referred to herein as “components”), the item listing system 100 of FIG. 2A support functionality described in FIGS. 1A-1G.

### Example Methods

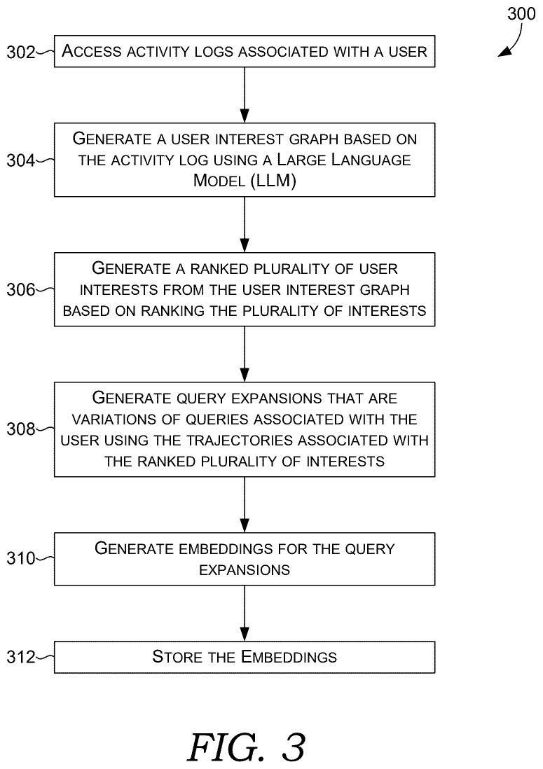

With reference to FIGS. 3, 4, and 5 flow diagrams that illustrate methods for providing an interest-driven recommendation engine in an artificial intelligence system. The methods may be performed using the artificial intelligence system described herein. In embodiments, computer memory or one or more computer-storage media having computer-executable or computer-useable instructions embodied thereon that, when executed, by one or more computer processors can cause the one or more computer processors to perform the methods (e.g., computer-implemented method) in the artificial intelligence system (e.g., a computerized system).

Turning to FIG. 3, a flow diagram is provided that illustrates a method 300 for providing an interest-driven recommendation engine in an artificial intelligence system. At block 302, the interest-driven recommendation engine accesses activity logs associated with a user. At block 304, an LLM of the interest-driven recommendation engine generates user interest graphs based on the activity log. At block 306, the LLM generates a ranked plurality of user interests from the user interest graph based on ranking the plurality of interests. At block 308, the interest-driven recommendation engine generates query expansions queries associated with the user using the trajectories associated with the ranked plurality of user interests. At block 310, the interest-driven recommendation engine generates embedding for the query expansions. At block 312, the interest-driven recommendation engine stores the embeddings.

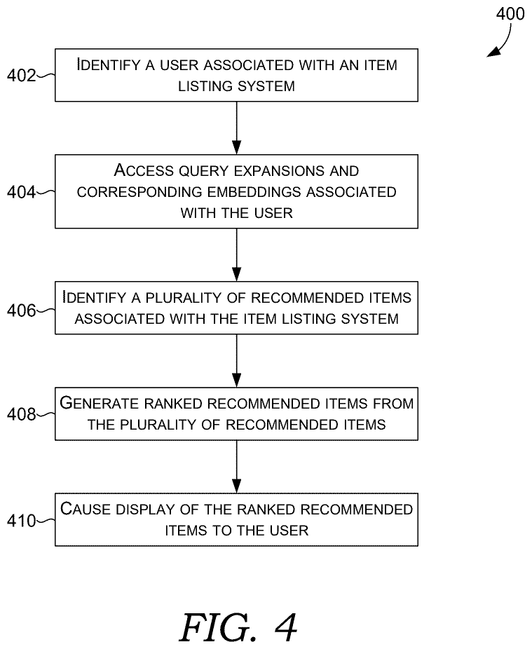

Turning to FIG. 4, a flow diagram is provided that illustrates a method 400 for providing an interest-driven recommendation engine in an artificial intelligence system. At block 402, the item listing system identifies a user associated with the item listing system. At block 404, the interest-driven recommendation engine accesses query expansions and corresponding embeddings associated with the user. At block 406, the interest-driven recommendation engine identifies a plurality of recommended items associated with the item listing system. At block 408, the interest-driven recommendation engine generates ranked recommended items from the plurality recommended items. At block 410, the interest-driven recommendation engine causes display of the ranked recommended items to the user.

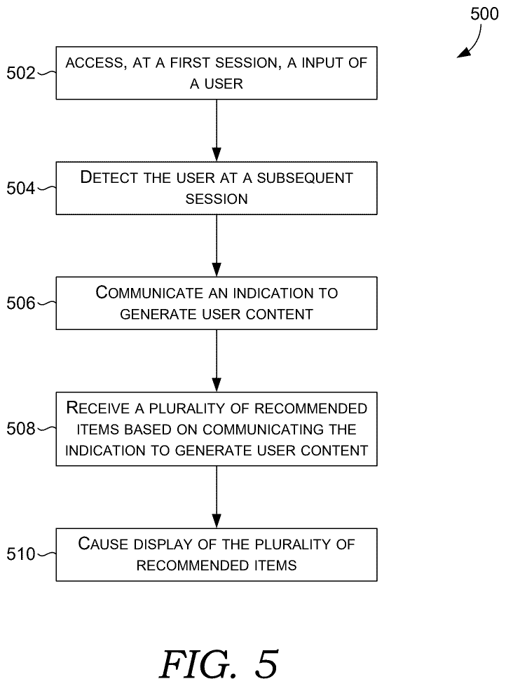

Turning to FIG. 5, a flow diagram is provided that illustrates a method 500 for providing an interest-driven recommendation engine in an artificial intelligence system. At block 502, a user client accesses input of a user at a first session. The input is associated with browsing an item listing system, the input causes generation of an activity log associated with the user. At block 504, the user client detects the user at a subsequent session. At block 506, the user client communicates an indication to generate user content. At block 508, the user client receives a plurality of recommended items based on communicating the indication to generate user content. The plurality of recommended items are generated based on query expansions and corresponding embeddings associated with the user. At block 510, the user client causes display of the plurality of recommended items.

### Technical Improvement

Embodiments of the present invention have been described with reference to several inventive features (e.g., operations, systems, engines, and components) associated with an customer service management system. Inventive features described include: operations, interfaces, data structures, and arrangements of computing resources associated with providing the functionality described herein relative with reference to an interest-driven recommendation engine associated with an artificial intelligence system.

Embodiments of the present invention relate to the field of computing, and more particularly to an artificial intelligence system. The following described exemplary embodiments provide a system, method, and program product to, among other things, execute generative AI security engine operations that provide interest-driven recommendation. Therefore, the present embodiments improve the technical field of artificial intelligence technology and item listing platform technology by providing by introducing a scalable, efficient, and nuanced approach to modeling user preferences and generating personalized recommendations.

For example, the technical solution leverages hierarchical user interest graphs, built via LLMs and refined using a teacher-student LLM paradigm, to capture both broad and specific user interests. This approach addresses key challenges in AI-driven recommendation systems, such as scalability, recency bias, and the ability to distinguish between utilitarian and passion-driven interests. By incorporating advanced techniques like query expansions, embeddings via eBERT, and learning-to-rank models, the technical solution ensures that recommendations are semantically rich, diverse, and contextually relevant, pushing the boundaries of personalization in AI systems.

In the domain of item listing platform technology, the technical solution enhances the efficiency and user experience of large-scale e-commerce platforms. The integration of stored embeddings and approximate-nearest-neighbors search allows the item listing system to deliver real-time recommendations even under heavy user traffic. Post-ranking diversification ensures that users receive a blend of highly relevant and inspirational suggestions, increasing engagement and driving discovery. The structured use of key-value databases, dynamic batching, and seamless system integration ensures that the platform can manage millions of daily users while maintaining high performance and responsiveness. Overall, this technical solution represents a significant improvement in both the scalability and quality of AI-driven item listing platforms.

Functionality of the embodiments of the present invention have further been described, by way of an implementation and anecdotal examples—to demonstrate that the operations for providing interest-driven recommendation using an interest-driven recommendation engine in an artificial intelligence system as a solution to a specific problem in artificial intelligence technology to improve computing operations in artificial intelligence systems. Overall, these improvements result in less CPU computation, smaller memory requirements, and increased flexibility in artificial intelligence systems when compared to previous conventional artificial intelligence system operations performed for similar functionality.

### Additional Support for Detailed Description of the Invention

### Example Item Listing System Environment

Referring now to FIG. 6, FIG. 6 illustrates an example item listing system 600 computing environment in which implementations of the present disclosure may be employed. In particular, FIG. 6 shows a high level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services—including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 626) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the item listing system's functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 674 supports the process of building, training, and fine-tuning machine learning models. Machine learning training data 674 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including: content generation, product image generation, personalized product recommendations, natural language chatbots, and content summarization. Traditional AI models encompass a wide range of algorithms and techniques and can be employed in various ways including: recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

Item listing system 600 provides item listing system data that informs customer service interactions, and as such, can operate with a customer service management system to address any issues or questions that arise from those item listings. A customer service management system can be software solution designed to streamline and automate the handling of customer inquiries and support requests across various communication channels. The customer service management system centralizes customer interactions, allowing service teams to efficiently categorize, prioritize, and resolve issues, while tracking and managing each case through its lifecycle. With integrated tools such as ticketing systems, knowledge bases, and automation features like AI-driven chatbots, it enhances response times, reduces manual effort, and ensures consistent, high-quality customer service. The item listing system and customer service management system can be integrated to ensure seamless communication and efficient resolution of customer concerns.

### Example Distributed Computing System Environment

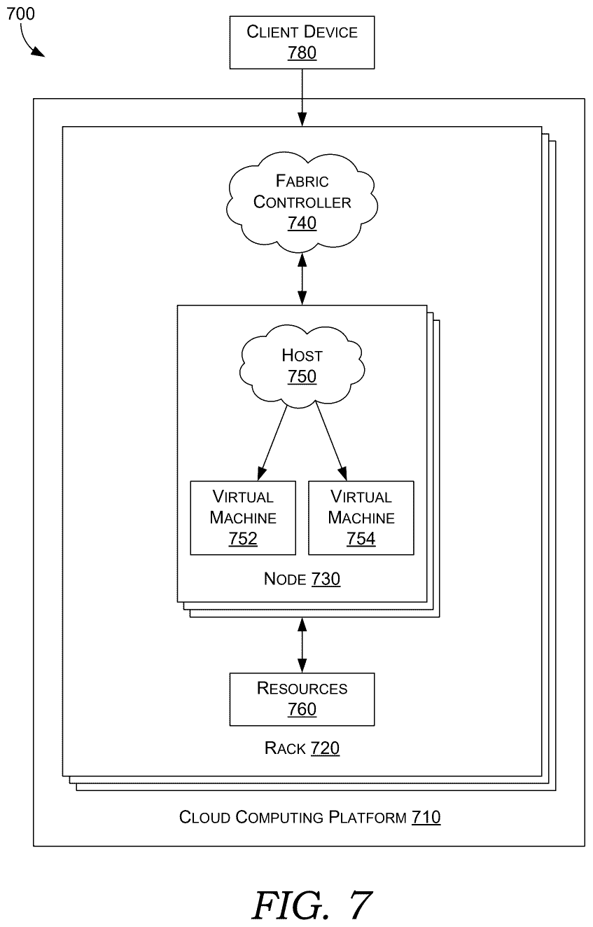

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

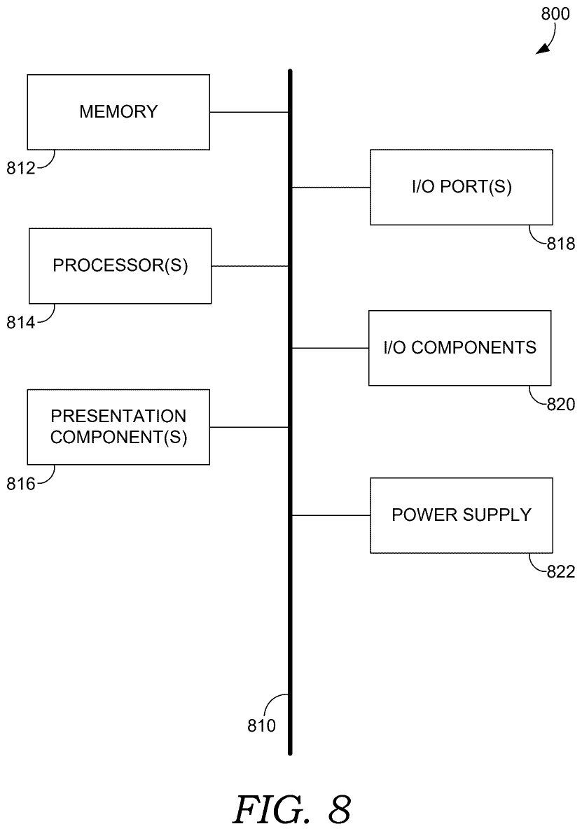

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors;
computer memory storing computer-useable instructions that, when used by the one or more computer processors, cause the one or more computer processors to perform operations, the operations comprising:
accessing an activity log associated with a user;
using a Large Language Model (LLM) and the activity log, generating a user interest graph;
generating a ranked plurality of user interests from the user interest graph based on ranking a plurality of user interests, the ranked plurality of user interests are associated with corresponding trajectories;
using the corresponding trajectories associated with the ranked plurality of user interests, generating query expansions that are variations of queries; and
generating embeddings for the query expansions, wherein the embeddings are vector representations of the query expansions that support identifying recommended items for the user.

2. The computerized system of claim 1, wherein generating the user interest graph is further based on a second LLM, wherein the second LLM is a smaller fine-tuned LLM that replicates a graph generation processes of the user interest graph based on a teacher-student paradigm.

3. The computerized system of claim 1, wherein the user interest graph is a hierarchical graph that organizes user interactions into user interests to highlight relationships and trajectories associated with transient preferences and persistent preferences, and wherein nodes in the user interest graph represent the user interests, the nodes comprising source nodes representing broad categories and sink nodes represent narrow interests, wherein the relationships between the nodes are defined based on user behavior.

4. The computerized system of claim 1, the operations further comprising pruning of nodes in the user interest graph, wherein the pruning of the nodes is based on identifying the nodes that are tagged with predefined need categories.

5. The computerized system of claim 1, wherein ranking the plurality of user interests is based on scoring nodes using scoring features comprising interest type, a number of associated search sessions, and diversity metrics.

6. The computerized system of claim 1, wherein generating the query expansions is based on interest-to-recall that employs an interest-to-recall LLM to transform trajectories into the query expansions, wherein the query expansions are formatted as structured text.

7. The computerized system of claim 1, the operations further comprising storing the user interest graph, trajectories, and the embeddings in a key-value database.

8. The computerized system of claim 1, wherein the embeddings are generated to align with an inventory of an item listing system associated with the user.

9. The computerized system of claim 1, the operations further comprising:
identifying the user during a subsequent session;
accessing the query expansions and the embeddings associated with the user;
identifying a plurality of recommended items associated with an item listing system;
generating ranked recommended items from the plurality of recommended items; and
causing display of the ranked recommended items to the user.

10. The computerized system of claim 9, wherein generating the ranked recommended items is based on a learning-to-rank (LTR) model that scores the plurality of recommended items based on features comprising user preferences, item attributes, and contextual relevance; and wherein generating the ranked recommended items is based on post-ranking diversification that balances practical relevance and discovery associated with the ranked recommended items.

11. The computerized system of claim 1, the operations further comprising:
accessing, at a first session, an input of the user, the input is associated with browsing an item listing system, wherein the input causes generation of the activity log associated with the user;
detecting the user at a subsequent session;
based on detecting the user, communicating an indication to generate user content;
based on communicating the indication to generate the user content,
receiving a plurality of recommended items, wherein the plurality of recommended items are identified based on the query expansions and the embeddings associated with the user; and
causing display of the plurality of recommended items.

12. A computer-implemented method, the computer-implemented method comprising:
accessing query expansions associated with a user;
based on the query expansions, identifying a plurality of recommended items associated with an item listing system;
generating ranked recommended items from the plurality of recommended items; and
causing display of the ranked recommended items to the user.

13. The computer-implemented method of claim 12, wherein the query expansions and corresponding embeddings are associated with a user interest graph based on an activity log of the user, the user interest graph is a hierarchical graph that organizes user interactions into user interests to highlight relationships and trajectories associated with transient preferences and persistent preferences.

14. The computer-implemented method of claim 12, wherein the query expansions are associated with embeddings that are generated based on the query expansions to align with an inventory of the item listing system associated with the user, wherein the embeddings are vector representations of the query expansions that support identifying recommended items for users.

15. The computer-implemented method of claim 12, wherein identifying the plurality of recommended items is based on an approximate-nearest-neighbors (ANN) algorithm that supports identifying item embeddings associated with the plurality of recommended items that are closest to the item embeddings.

16. The computer-implemented method of claim 12, wherein generating the ranked recommended items is based on a learning-to-rank (LTR) model that scores the plurality of recommended items based on features comprising user preferences, item attributes, and contextual relevance; and wherein generating the ranked recommended items is based on post-ranking diversification that balances practical relevance and discovery associated with the ranked recommended items.

17. One or more computer-storage media having computer-executable instructions embodied thereon that, when executed by a computing system having a processor and memory, cause the processor to perform operations, the operations comprising:
accessing, at a first session, a input of a user, the input is associated with browsing an item listing system, wherein the input causes generation of an activity log associated with the user;
detecting the user at a subsequent session;
based on detecting the user, communicating an indication to generate user content;
based on communicating the indication to generate the user content, receiving a plurality of recommended items, wherein the plurality of recommended items are generated based on query expansions;
wherein the query expansions are associated with a user interest graph based on the activity log of the user, the user interest graph is a hierarchical graph that organizes user interactions into user interests to highlight relationships and trajectories associated with transient preferences and persistent preferences; and
causing display of the plurality of recommended items.

18. The media of claim 17, wherein nodes in the user interest graph represent the user interests, the nodes comprising source nodes representing broad categories and sink nodes represent narrow interests, wherein the relationships between the nodes are defined based on user behavior.

19. The media of claim 17, wherein the query expansions are associated with embeddings that are generated based on the query expansions to align with an inventory of the item listing system associated with the user, wherein the embeddings are vector representations of the query expansions that support identifying recommended items for users.

20. The media of claim 17, wherein the plurality of recommended items are ranked recommended items, wherein the ranked recommended items are ranked based on a learning-to-rank (LTR) model that scores the plurality of recommended items based on features comprising user preferences, item attributes, and contextual relevance; and wherein the ranked recommended items are ranked based on post-ranking diversification that balances practical relevance and discovery associated with the ranked recommended items.
